(19) United States
(12) Patent Application Publication
(10) Pub. No.: US 2007/0129883 A1
(43) Pub. Date: Jun. 7, 2007

(54) METHOD AND APPARATUS FOR WALK GUIDANCE

(76) Inventors: Ming-Jen Kuo, Taipei City (TW); Li-Wen Huang, Chiayi County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/309,604

(22) Filed: Aug. 30, 2006

(30) Foreign Application Priority Data
Dec. 5, 2005 (TW) 94142749

(51) Int. Cl. G01C 21/30

(52) U.S. Cl. 701/209; 701/213

(57) ABSTRACT

A method and an apparatus for walk guidance are disclosed. First, a mobile device receives a start point and an end point so as to create a plurality of voice suggestion points. Next, the mobile device is in a walk guidance mode. When the present location is closer to one of a plurality of voice suggestion points within a predetermined distance, the mobile device sends a non-voice guidance message to remind the user, so as to avoid missing the planned route.

### CROSS-REFERENCE TO RELATED APPLICATION

This application claims the priority benefit of Taiwan application serial no. 94142749, filed on Dec. 5, 2005. All disclosure of the Taiwan application is incorporated herein by reference.

### BACKGROUND OF THE INVENTION

1. Field of Invention

The present invention relates to a method for walk guidance. More particularly, the present invention relates to a method for walk guidance, which transmits guidance message using a plurality of guiding and suggestion functions in a mobile device.

2. Description of Related Art

Many devices originally used in advanced technologies have been gradually applied in our daily life along with the technology improvement, which further enhances the convenience of everyday life. For example, the global position system (GPS) has become prevalent and broadly adopted by the public.

GPS is a positioning device using the satellite and the radio technology to provide accurate positioning for the user. In the early days, the GPS was strictly limited to the use in military unit for military purposes, for example, the accurate localization of the fighter planes, vessels, vehicles, persons, and attack targets, etc. Now, GPS has been open for civil use. The technology combining the space satellite and communication technology has been prosperously developed in the market and has revolutionarily changed the applications. For example, a driver can accurately plan the route and the time to arrive at the destination by GPS, or the driver can know his/her present location and the destination through the electronic map.

However, although more and more mobile devices with guidance function provide vehicle and walk guidance modes, the users using walk guidance mode may often neglect the voice message from the mobile devices because the surroundings of a walker are usually noisier than that inside of a vehicle. If the voice message neglected is an important message (for example, “please turn left in the next intersection”), the user may miss the original planned route.

### SUMMARY OF THE INVENTION

Accordingly, the present invention is directed to provide a method and mobile device for walk guidance, which sends guidance message through vibration mode to remind the users about traffic information.

As there is much noise interference in open environment, another aspect of the present invention is to further provide a method and mobile device for walk guidance, suitable for a pedestrian, and further suitable for particular persons such as blind people.

The present invention provides a method for walk guidance, suitable for the mobile devices with GPS function. The method for walk guidance includes: first, the mobile device receives a start point and an end point to create a plurality of voice suggestion points; next, the mobile device is entered into a walk guidance mode; when the present location is closer to one of a plurality of voice suggestion points within a predetermined distance, the mobile device sends a non-voice guidance message to remind the user.

The method for walk guidance according to one preferred embodiment of the present invention further includes: first, the GPS is enabled; next, the mobile device determines whether the GPS has been initialized completely; then, the mobile device sends a completion message when the GPS completes its initialization.

According to the preferred embodiment of the present invention, the completion message includes a voice message and a vibration message.

According to one preferred embodiment of the present invention, the present location is the location where the GPS detects when the initialization is completed.

The method for walk guidance according to one preferred embodiment of the present invention further includes: when the present location is closer to one of a plurality of voice suggestion points within a predetermined distance, the mobile device sends a detailed voice guidance message.

The present invention provides a mobile device including a GPS, a plurality of input devices, a CPU, and a suggestion device. Wherein, the GPS is suitable for positioning a present location. One of the multiple input devices is used for receiving the walk guidance start command input by the user. Next, the CPU is coupled with the GPS and the plurality of input devices and is entered into walk guidance mode according to the received walk guidance start signal. And, when the present location is closer to one of the plurality of voice suggestion points within a predetermined distance, the CPU outputs an guidance signal. Next, the suggestion device is coupled with the CPU and receives the guidance message to send a non-voice guidance message.

According to one preferred embodiment of the present invention, the input devices can be press keys.

According to one preferred embodiment of the present invention, when the present location is closer to one of the plurality of voice suggestion points within a predetermined distance, the CPU may further have the suggestion device to send a detailed voice guidance message.

According to one preferred embodiment of the present invention, one of the multiple input devices is used for the user to input a start point and an end point.

According to one preferred embodiment of the present invention, each of the input devices is disposed with raised points, suitable for a visually impaired user to distinguish the function of each input device.

According to one preferred embodiment of the present invention, the non-voice guidance message may be a vibration message.

According to the method and mobile device for walk guidance of the present invention, when a user is in a noisy environment and does not notice the voice message sent by the mobile device, the mobile device for walk guidance of the present invention can send a vibration message to remind the user about the traffic information. Moreover, raised points on the function keys of the mobile devices are provided for Braille readers, so that it is more convenient for the blind or visually impaired users.

In order to the make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a mobile device according to one preferred embodiment of the present invention.

FIG. 2 is a flow chart of a method for walk guidance according to one preferred embodiment of the present invention.

FIG. 3 is a diagram showing the mobile device according to one preferred embodiment of the present invention.

### DESCRIPTION OF EMBODIMENTS

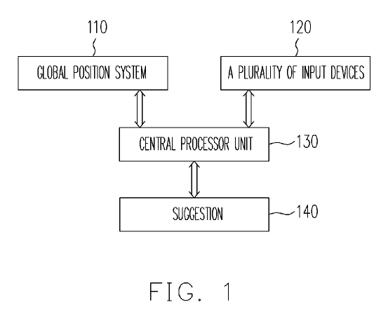

Referring to FIG. 1, FIG. 1 is a block diagram of a mobile device according to one preferred embodiment of the present invention. The mobile device includes a GPS 110, a plurality of input devices 120, a CPU 130, and a suggestion device 140. Those skilled in the art can easily learn that the mobile device may be a note book, a smart phone, a personal digital assistant (PDA), a pocket PC, or a mobile phone; however, the mobile device is not limited by those.

In the embodiment, the GPS 110 is for positioning a present location. A plurality of input devices 120 are, for example, press keys, and one of the press keys can be further provided for the user to input a start point and an end point besides receiving the start walk guidance start command input by the user.

The CPU 130 is coupled with the GPS 110 and the input devices 120 and is entered into walk guidance mode according to the walk guidance start signal received by the input device 120. Then, when the present location located by the GPS 110 is closer to one of a plurality of voice suggestion points within a predetermined distance, a guidance signal is output. The multiple voice suggestion points are defined by software. The software sets up the rules to automatically define the voice suggestion points in the route formed between the start point and the end point.

The suggestion device 140 is coupled with the CPU 130 to receive the guidance signal output from the CPU 130 and send a non-voice guidance message or a detailed voice guidance message, wherein the non-voice guidance message may be, for example, a vibration message. The following will describe the working theory of the present invention in detail.

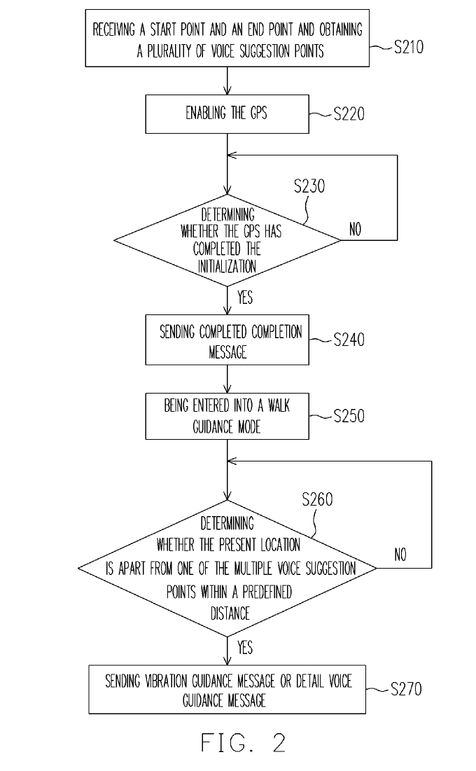

Referring to FIG. 2, FIG. 2 is a flow chart of a method for walk guidance according to one preferred embodiment of the present invention. The following will describe the flow chart accompanying FIG. 1. First, before being entered into the walk guidance mode (S250), a mobile device receives a start point and an end point through the input devices 120, for example, press keys. Next, according to an guidance software, the mobile device further plans the route to create a plurality of voice suggestion points (S210) according to the locations of the start point and the end point.

Next, the CPU 130 of the mobile device enables the GPS 110 (S220). After that, the CPU 130 determines whether the GPS 110 has completed the initialization (S230). When the CPU 130 determines that the GPS 110 has completed the initialization, it sends a completion message (S240). The completion message may be, for example, a voice message or a vibration message.

Next, the CPU 130 of the mobile device is entered into a walk guidance mode according to the walk guidance start command input to the multiple function keys 120 (S250).

Again, the CPU 130 of the mobile device determines whether the present location is closer to any one of the voice suggestion points within 5 meters (S260). If there is no any voice suggestion point within 5 meters, the CPU 130 may continue to caculate until one voice suggestion point is found. Wherein, the predefined distance in the embodiment is 5 meters, however, the range is not limited by it, and a user can apply to other predefined distance without departing from the spirit of the embodiment.

When the CPU 130 determines that the present location is closer to one of the multiple voice suggestion points within 5 meters, it sends a guidance signal to trigger the suggestion device 140 to send a non-voice guidance message, for example, a vibration guidance message, or a detailed voice guidance message (S270). Here, supposing that the non-voice guidance message is a vibration guidance message, the present invention can define that: the mobile device vibrates once to indicate “turn left” and vibrates twice to indicate “turn right”. For example, if the voice message in walk guidance mode is “please turn left in the next intersection”, the mobile device may vibrate once as a reminder, so that the dual suggestion modes can prevent the user from taking a wrong route resulting from not hearing of the voice suggestion message.

Users can get more appropriate route between the present location and the end point from the detailed voice guidance messages, not just simply suggestion of “please turn left or right at the intersection”, but suggestion of “turn left at the next intersection, and then go straight after the turn”. Furthermore, the information of the distance according to actual requirement, such as “turn left at the next intersection at 5 meters ahead, and then go straight about 20 meters to reach the company”, can also be added.

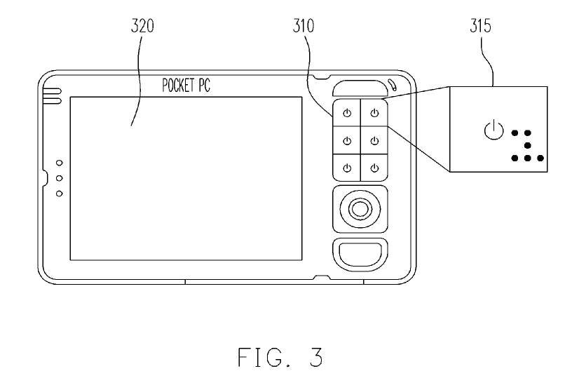

In one preferred embodiment of the present invention, point system (raised points or dots) can also be provided on the above mentioned multiple function keys so that a visually impaired person can Braille. Referring to FIG. 3, FIG. 3 is a diagram showing the mobile device according to one preferred embodiment of the present invention. In particular, a plurality of raised points on each of the keys 310 is used as the input devices, and the multiple raised points are the dots which a visually impaired person can comprehend through Braille system. As the key 315 shown, persons with visual impairments can understand the function of each function key through the point dots, so that the visually impaired persons do not need to find the correct function key by several trials. The mobile device of the present invention also includes a display device 320 to display the electric map and the proceeding route.

In summary, since the present invention applies the method for walk guidance, when a user is in a noisy environment and does not notice the voice message sent by the mobile device, the mobile device can send a non-voice guidance message, for example, a vibration or flashing message, and also send a voice of special frequency to remind the user about the traffic information. And, the original voice message can be further improved to provide more appropriate detailed voice guidance messages. It is remarkable that the method of the present invention can also be applied to guide visually impaired persons by disposing raised points on the input devices of the mobile device, or by adopting highly brightened and/or enlarged words. Unless the visually impaired person is totally blind, a user with visual impairments still can read the text and use the device without difficulty.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for walk guidance, applicable to mobile devices with GPS function, the method comprising:
receiving a start point and an end point;
creating a plurality of voice suggestion points;
entering into a walk guidance mode; and
sending a non-voice guidance message, when the present location is closer to one of the voice suggestion points within a predetermined distance.

2. The method for walk guidance as claimed in claim 1 further comprises:
enabling the GPS;
determining whether the GPS has been initialized completely; and
sending a completion message when the GPS completes initialization.

3. The method for walk guidance as claimed in claim 2, wherein the completion message comprises a voice message and a vibration message.

4. The method for walk guidance as claimed in claim 2, wherein the present location is the location GPS detected as the initialization completed.

5. The method for walk guidance as claimed in claim 1 further comprises: sending a detailed voice guidance message when the present location deviated from the voice suggestion points exceeding a predetermined distance.

6. The method for walk guidance as claimed in claim 1, wherein the non-voice guidance message is a vibration message.

7. A mobile device, comprising:
a GPS for positioning a present location;
a plurality of input devices, one of the input devices is for receiving a walk guidance start command inputted by a user;
a CPU, coupled with the GPS and the input devices and entered into a walk guidance mode according to the walk guidance start command, and outputting an guidance signal when the present location is closer to one of a plurality of voice suggestion points within a predetermined distance; and
a suggestion device, coupled with the CPU and receiving the guidance signal so as to send a non-voice guidance message.

8. The mobile device as claimed in claim 7, wherein the non-voice guidance message is a vibration message.

9. The mobile device as claimed in claim 7, wherein the CPU further triggers the suggestion device to produce a detailed voice guidance message, when the present location is closer to one of the voice suggestion points within a predetermined distance.

10. The mobile device as claimed in claim 7, wherein one of the input devices is capable of inputting a start point and an end point.

11. The mobile device as claimed in claim 7, wherein the input devices are with a plurality of raised point thereon.

12. The mobile device as claimed in claim 7, wherein the input devices are keys.
